(19) United States
(12) Patent Application Publication
(10) Pub. No.: US 2016/0033423 A1
(43) Pub. Date: Feb. 4, 2016

(54) Millimeter Wave Scanning Imaging System

(71) Applicant: SPINNER GmbH, Munchen (DE)

(72) Inventors: Hans-Ulrich NICKEL, Neubiberg (DE); Christian KREBS, Koblenz (DE); Dirk NÜßLER, Vettelschob (DE)

(21) Appl. No.: 14/885,402

(22) Filed: Oct. 16, 2015

Related U.S. Application Data
(63) Continuation of application No. PCT/EP2014/057958, filed on Apr. 17, 2014.

(30) Foreign Application Priority Data
Apr. 23, 2013 (EP) 13165014.5

(51) Int. Cl. G01N 22/00

(52) U.S. Cl. CPC G01N 22/00

(57) ABSTRACT

A millimeter wave scanning imaging system for scanning objects comprises a transport means for transporting the objects in a first direction, a millimeter wave measurement system and a scanning system. The millimeter wave measurement system comprises a transmitter coupled to a first antenna and a receiver coupled to a second antenna, which are arranged distant to each other and form a gap through which the objects can be transported. The scanning system generates a synchronous arc-shaped movement of the first antenna and the second antenna. The signal from the transmitter is converted from H₁₀ mode into H₁₁ mode and coupled via a rotary joint in H₁₁ mode to the first antenna, thus maintaining the orientation or polarization of the signal constant with respect to the transport means over rotation.

### PRIORITY CLAIM

This application is a continuation of co-pending International Application No. PCT/EP2014/057958 filed on Apr. 17, 2014, which designates the United States and claims priority from European Application No. 13165014.5 filed on Apr. 23, 2013, each of which is incorporated herein by reference in its entirety.

### BACKGROUND OF THE INVENTION

1. Field of the Invention

The invention relates to a millimeter wave scanning imaging system for generating images of objects by using electromagnetic waves with wavelengths in a millimeter range.

2. Description of Relevant Art

A food scanning device using electromagnetic RF radiation is disclosed in DE 10 2009 047300 A1. It has a source for generation for RF radiation and directing this radiation to a food article. The reflected radiation is received by a receiver and analyzed to obtain information about the composition of the food.

A scanning imaging system using millimeter waves is disclosed in US 2002/0044276 A1. Herein, a scanning reflector is used to sweep through a periodic scan pattern to redirect millimeter wave energy from a target object to a detector.

### SUMMARY OF THE INVENTION

The embodiments are based on the object of providing a millimeter wave scanner for continuous scanning of objects. A further object is to achieve a high-resolution scan with low distortion. Furthermore, an object is to provide a comparatively simple, cost-efficient, and maintenance-free scanner. Another object is to provide a rotational scanning section, which delivers and receives electromagnetic waves with a constant and scanning angle independent polarization.

In a first embodiment, the scanning imaging system uses electromagnetic waves, preferably radio frequency energy (or signals) to scan objects. Preferably, the wavelengths of the electromagnetic waves are in a millimeter range. A preferred frequency range is between 30 GHz and 300 GHz. The embodiments disclosed herein may also be used for centimeter waves (3 GHz to 30 GHz) or sub-millimeter waves (300 GHz to 3 THz). Also light may be used for scanning.

The objects to be scanned are preferably moved or transported into a first direction by a transport means, which preferably is a conveyor belt. Other transport means, like trolleys or sliders, may be used. Herein, a conveyor belt is preferred, as it provides transport of the objects at a predetermined and constant speed, and it has a constant object throughput. At least one antenna for emitting and/or receiving electromagnetic waves is moved into a second direction, approximately at a right angle to the first direction. Movement may also take place on a curved track. It is preferred to have a separated first transmission antenna and a second receiving antenna. There may also be a plurality of transmission antennas and/or receiving antennas. It is further preferred to have a gap between the antennas, through which the objects are moved. This allows for transmission measurement of the objects. In an alternate embodiment, both antennas may be arranged at one side of the object to allow for reflection measurements. Alternatively, there may be a common antenna for transmitting and receiving of the signals. To obtain a continuous movement of the transmitting and receiving antennas, they are preferably arranged at a rotating body. This rotating body preferably is disk-shaped. It may be a disk holding at least one of the antennas. It may hold and/or support further components, like position sensors or balancing weights. It is further preferred, if there are two rotating bodies, rotating synchronously and holding the transmitting antenna and the receiving antenna opposite to each other. The rotating bodies may be driven by belts or a gear. It is further preferred, if the rotating bodies have a fluid bearing, preferably an air bearing or a liquid bearing, or alternatively a magnetic bearing. Such frictionless bearings allow for comparatively high rotational speeds, and therefore high scanning speeds.

The transmitting antenna is connected to a transmitter system, while the receiving antenna is connected to a receiver system. The transmitter system delivers RF energy, while the receiver system receives the energy and generates signals to be used in an image-processing unit to generate images. Preferably, the image-processing unit evaluates the signal as received by the receiving antenna in its amplitude and/or phase and most preferably compares this to the signal transmitted by the transmitting antenna. Furthermore, changes in polarization may be evaluated. Preferably, the transmitter system and/or the receiver system are stationary and not rotating, as this reduces the rotating mass and therefore increases rotating speed and scanning speed. For transfer of the RF energy (or also referred herein as electromagnetic waves or the signal) from the transmitter system to the transmitting antenna, a first waveguide system is provided. This first waveguide system has at least a first rotary joint to couple between stationary and rotating parts. There is preferably a second waveguide system for coupling electromagnetic waves from the receiving antenna to the receiver. It is also preferred, if this waveguide system has a second rotary joint to couple electromagnetic waves between rotating and stationary parts.

The transmitting and receiving antennas cross the conveyor belt with an arc-shaped movement from one side to the other side. Preferably, this movement has at the center of the conveyor belt a tangent perpendicular to the direction of movement of the conveyor belt. Generally, this arc shaped movement roughly represents a movement perpendicular (or under a right angle) to the direction of movement of the conveyor belt.

In a preferred embodiment, the waveguide system keeps the orientation of the electromagnetic field or the polarization of the electromagnetic waves constant over rotation, at least over the arc-shaped segment of the scanning movement on the conveyor belt. This is done by using waves having H₁₁ mode from the transmitter system. The transmitter system may have a transmitter which directly generates waves having H₁₁ mode in a circular waveguide. An alternative may be converting the electromagnetic waves from the transmitter, which may be guided by a rectangular waveguide in an H₁₀ mode into waves having H₁₁ mode by a mode converter. Such a mode converter may be a waveguide having a continuous transition between the both waveguide types. It may also be integrated into an OMT (orthomode transducer). There may also be an OMT anywhere else in the signal path between the transmitter and the receiver. This H₁₁ mode is guided in a first stationary circular waveguide, which is connected to a first rotary joint. The first stationary circular waveguide may be a very short piece of a waveguide, which may be integrated into either the mode converter or the first rotary joint. This first rotary joint is a rotary joint for connecting circular waveguides using an H₁₁ mode on both sides. Most preferably, it is a circular waveguide having at least one λ/4 transformer for electrically closing the gap between the rotating parts. This may also be called a λ/4 choke. The rotating side of the first rotary joint is coupled to a first rotary circular waveguide for transferring the electromagnetic waves to the first antenna. Preferably, the first antenna is a circular, conical or exponential horn antenna. Generally, although horn antennas are preferred, the antennas used herein may be any kind of antennas suitable for transmitting and receiving the millimeter wave signals. Preferably, the horn antennas have a circular cross section and may also be referred to as circular cross-sectioned antenna or horn. They may further have a conical or exponential shape.

By using the before mentioned rotary joint and the circular waveguides, the orientation (and polarization) of the electric fields remains constant over rotation with respect to the stationary parts. This helps to improve scan quality and the solution. Herein, the terms “circular waveguide” and “circular antenna” relate to waveguides and antennas having an approximately circular cross section. Such antennas may further have a conical shape.

Preferably, a similar arrangement is provided at the second side with the second antenna for receiving signals connected to the receiver system. Here also, the receiver system may comprise a receiver which directly receives H₁₁ mode signals from a circular waveguide or a mode converter is provided for converting such H₁₁ mode signals into an H₁₀ mode within a rectangular waveguide.

In an alternative embodiment, a state of the art rotary joint is used to transfer the signal from the second antenna, which acts a receiving antenna, to the receiver. Such a rotary joint generally may have inputs and outputs as rectangular waveguides using H₁₀ modes. Due to the rotation of the polarization of the receiving antenna system (including the rotary joint), there may be some attenuation of the signal, which may be compensated by calculation. Although the previous embodiment is related to circular waveguides using H₁₁ modes, there may be other modes having similar characteristics and which may be used as alternatives. Such modes are HE₁₁ mode in ridged or corrugated circular waveguides or circular waveguides coated with a dielectric. A further embodiment would use HE₁₁ modes with dielectric waveguides. Such dielectric waveguides may also be optical fibers.

Another embodiment relates to a method for operating a scanning imaging system having a stationary transmitter coupled to a rotating circular antenna. The signals from the transmitter are transferred via a first stationary rectangular waveguide in H₁₀ mode via a mode converter for converting an H₁₀ mode signal into an H₁₁ mode signal, which is further coupled via a first stationary circular waveguide, carrying the H₁₁ signal to a first rotary joint for coupling the H₁₁ mode signal into a first rotating circular waveguide which furthermore couples the signal to the antenna. This method may be combined with all further embodiments disclosed herein.

### BRIEF DESCRIPTION OF THE DRAWINGS

In the following, the invention will be described by way of example, without limitation of the general inventive concept, on examples of embodiment and with reference to the drawings.

FIG. 1 shows a first embodiment of a transmissive scanning imaging system in a side view.

FIG. 2 shows the first embodiment of a scanning imaging system in a top view.

FIG. 3 shows a second embodiment of a reflective scanning imaging system in a side view.

FIG. 4 shows a scanning process in detail.

FIG. 5 shows the signal path between transmitter and receiver.

FIG. 6 shows an alternate embodiment, using standard rotary joints.

FIG. 7 shows the orientation of the electromagnetic waves as transmitted by first circular antenna, in a top view.

FIG. 8 shows the orientation of the electromagnetic waves as transmitted by first rectangular antenna, in a top view.

FIG. 9 shows the effect of a non-rotating electrical field on scanning.

FIG. 10 shows the effect of a rotating electrical field on scanning.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

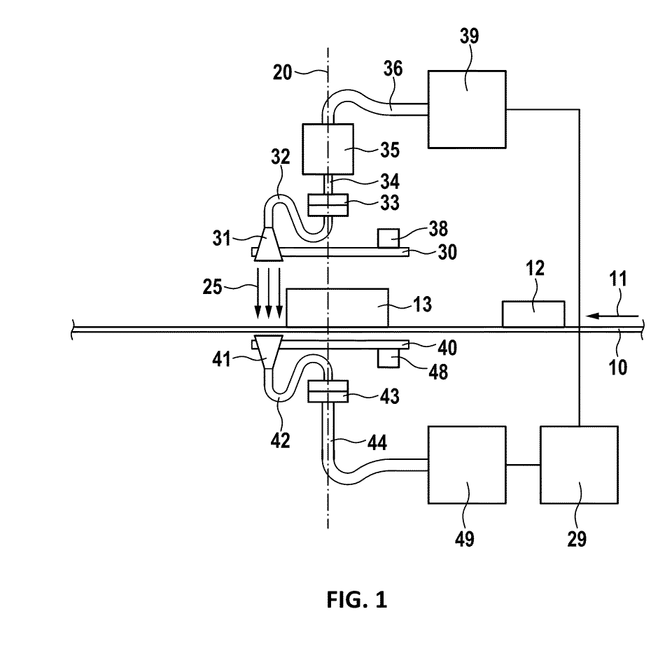

In FIG. 1, a first embodiment of a transmissive scanning imaging system is shown in a side view. The objects 12, 13 to be scanned are transported by a belt conveyor 10 in direction 11. For generating images of these objects, electromagnetic waves are generated by a transmitter 39, radiated to the objects by a first antenna 31, received by a second antenna 41, in propagating direction 25, and forwarded to a receiver 49. An image-processing unit 29 receives the signal of the receiver 49 together with further signals, like synchronization signals of transmitter 39, and calculates an image of the objects. The image-processing unit 29 may deliver synchronization and/or control signals to the transmitter 39 and/or the receiver 49, and/or other components of the scanner. For scanning over the surface of the an object, the object is moved into a first direction by the conveyor belt, whereas the first antenna 31 and/or the second antenna 41 are moved in a direction approximately under a right angle to the direction of movement of the conveyor belt. More precisely, they perform a rotational movement crossing the conveyor belt in a specific sector of this movement, as will be described further below. For this purpose, at least a first rotating base 30 is provided. This first rotating base 30 is designed for holding at least a first antenna 31. There may be other components attached to the first rotating base, like auxiliary components 38, which may comprise at least one balancing weight for statically and/or dynamically balancing the rotating base. The rotating base 30 is rotatable about an axis of rotation 20. Preferably, it is supported by at least one bearing, which is not shown in here. For coupling the first antenna 31 to the transmitter 39, a first rotating waveguide 32 is connected to the antenna 31. This is further connected to a first rotary joint 33, which is again connected at its stationary side via a first stationary circular waveguide 34 to a mode converter 35. In an exemplary embodiment of a transmitter system, the transmitter 39 is connected via a first stationary rectangular waveguide 36 to said mode converter. In the receiving section, there is a second rotating base 40 corresponding to first rotating base 30. Both rotating bases are rotating synchronously, so that the first antenna 31 at the first rotating base 30 and the second antenna 41 at the second rotating base 40 are in a fixed position relative to each other, during rotation. There may be further auxiliary components 48 at the second rotating base, like electronic components or balancing weights. The second antenna 41 is connected via a second rotating circular waveguide 42, a second rotary joint 43, and a second stationary circular waveguide 44 to the receiver system, which comprises a receiver 49, which can directly receive H₁₁ mode signals from a circular waveguide.

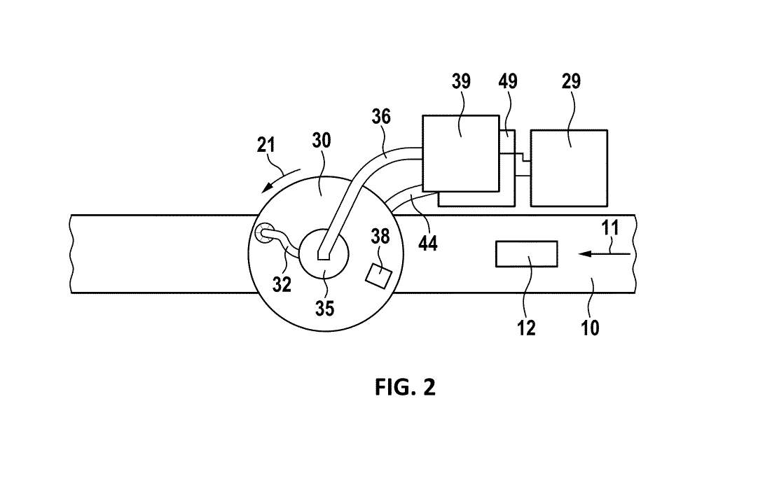

In FIG. 2, the first embodiment of a scanning imaging system is shown in a top view. Here, the direction of rotation 21 of the first rotating base 30 is shown. The first rotating base may also be rotating in the opposite direction.

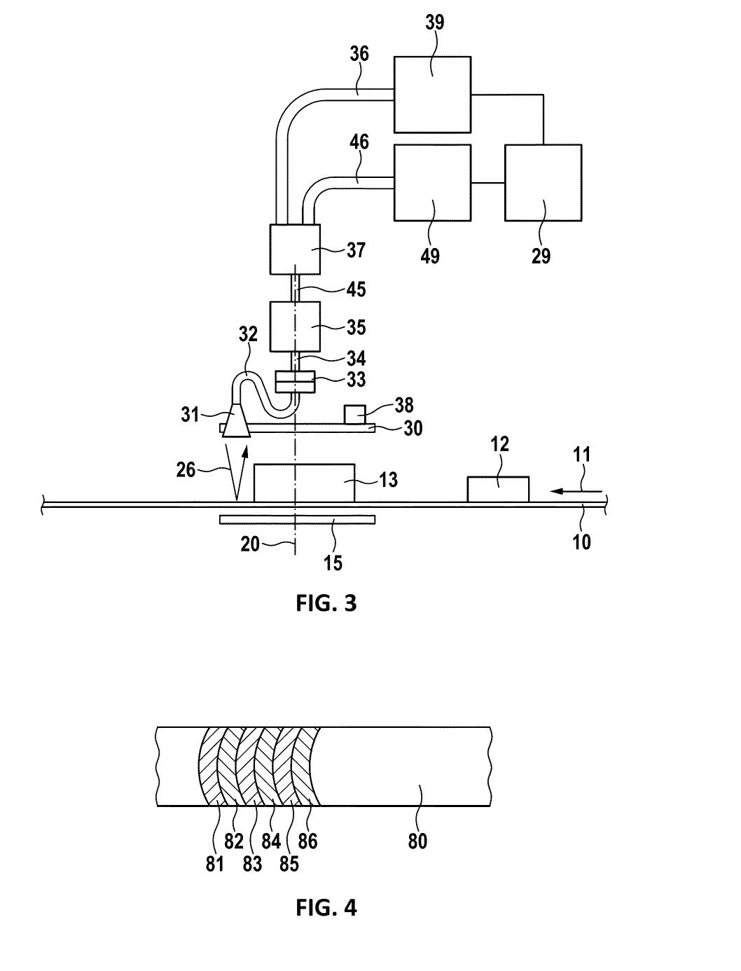

In FIG. 3, a second embodiment using a reflective mode is shown in a side view. Here, only a first antenna 31 is provided at a first rotating base. This antenna is used for transmitting the receiving electromagnetic waves. For coupling the same antenna to transmitter 39 and receiver 49 via first stationary rectangular waveguide 36 and second stationary rectangular waveguide 46, a direction selective coupling device 37 is provided. This may for example be a directional coupler or a magic-T. It is further coupled via a rectangular waveguide 45 to the mode converter 35. Furthermore, there may be an absorber 15 below the conveyor belt to absorb non-reflected radiation. During a scan, a signal is transmitted from the transmitter 39 via first stationary rectangular waveguide 36 and the direction selective coupling device 37, waveguide 45, mode converter 35, first stationary circular waveguide 34, rotary joint 33, first rotating circular waveguide 32, to first antenna 31. This antenna emits the signal into direction 26, which is reflected back and received by the same first antenna 31. From there, it is guided back by the components as described above to the direction selective coupling device 37, which guides the reflected signal via second stationary rectangular waveguide 46 to the receiver 49.

In FIG. 4, a scanning of an area 80 is shown in detail. The scanned area 80 may be the surface of conveyor belt 11, on which some objects 12, 13 are located. The first antenna 31 and the second antenna 41 perform a circular movement resulting in arch-shaped tracks 81, 82, 83, 84, 85, and 86. By placing these arch-shaped tracks adjacent to each other, the whole surface may be scanned.

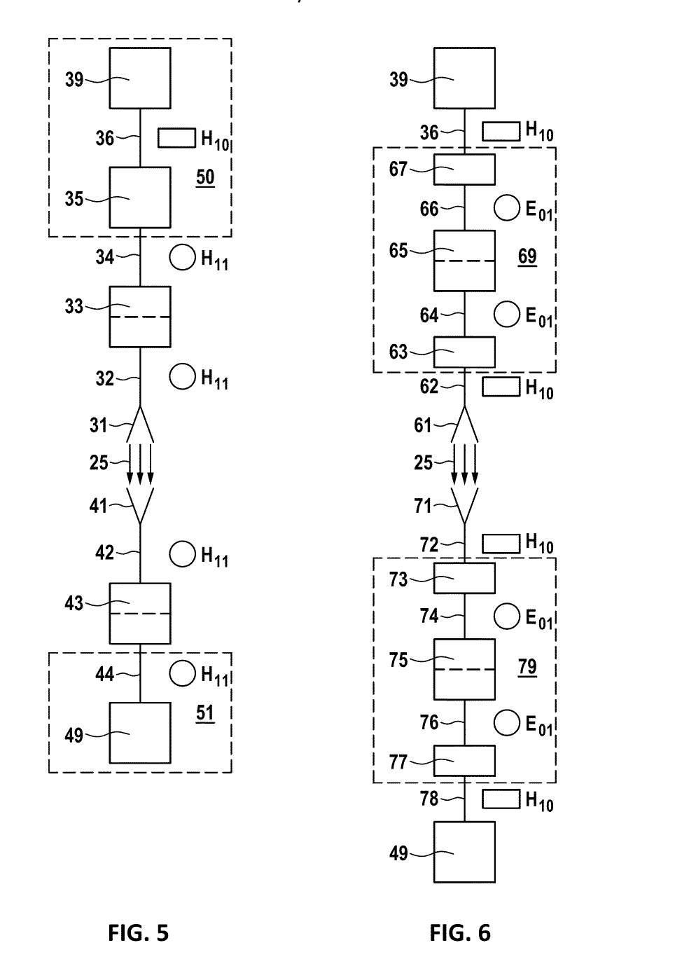

In FIG. 5, the signal path between transmitter 39 and receiver 49 is shown in detail. The electromagnetic waves are generated by a transmitter system comprising a transmitter 39, a first stationary rectangular waveguide 36, and a mode converter 35. In the detail, they are generated by transmitter 39 and are coupled by means of a first stationary rectangular waveguide 36 to a mode converter 35. In this figure, a cross-section of each waveguide together with the preferred transmission mode is shown. Accordingly, the first stationary rectangular waveguide 36 has a rectangular cross-section, and its preferred propagation mode is H₁₀. The mode converter 35 converts the H₁₀ mode received by a rectangular waveguide into an H₁₁ mode in a first stationary circular waveguide 34. This signal in an H₁₁ mode from a circular waveguide is coupled by the first rotary joint 33 to another H₁₁ mode in first rotating circular waveguide 32. The signal propagating there through is emitted by first antenna 31 in direction of transmission 25. The signal received by the second antenna 41 is conducted by the second rotating circular waveguide 42 in an H₁₁ mode, and transferred by the second rotary joint 43 into the receiver system 51 in an H₁₁ mode. The receiver system comprises the second stationary circular waveguide 44 and the receiver 49.

In FIG. 6, an alternate embodiment using standard rotary joints is shown. This embodiment is based on standard technology, using the preferred rectangular waveguides for transporting signals in H₁₀ mode. There are many rotary joints for H₁₀ mode signals having rectangular waveguide connectors available in the market. Such standard rotary joints 69, 79 include a first and second mode converter 67, 77, for converting an incoming H₁₀ mode of a rectangular waveguide into an outgoing E₀₁ mode of a circular waveguide 66, 76. This signal is further coupled by a circular rotary joint 65, 75 into another circular waveguide 64, 74, transporting the same E₀₁ mode. Finally, this is converted by a second mode converter 63, 73 back to an H₁₀ mode in a rectangular waveguide. The standard rotary joints 69, 79 as described herein may be operated in a direction as shown or into an opposite direction thereto. Accordingly the system uses a transmitter 39 producing signals into a first stationary rectangular waveguide 36 in H₁₀ mode coupling the signal over a standard rotary joint 69 via a first rotating rectangular waveguide 62 in H₁₀ mode to a rectangular transmission antenna 61. This signal is radiated into direction 25 to the second rectangular antenna 71. From there, it is again coupled through second rotating rectangular waveguide 72, using H₁₀ mode via a standard rotary joint 79 by a second stationary rectangular waveguide 78 using H₁₀ mode to the receiver 49.

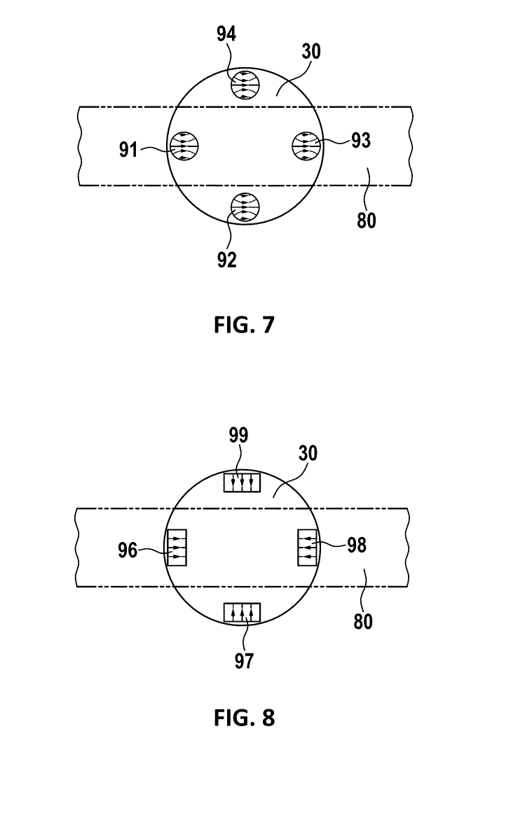

In FIG. 7, the orientation of the electromagnetic waves as transmitted by first circular antenna 31, in a top view is shown. This figure relates to the first embodiment as shown in FIG. 5. The arrows show the direction of the E-field (electrical field) in the cross-sections 91, 92, 93, 94 of a circular antenna 31, 41, at different positions, which are under an angle of approximately 90 degrees to each other. The direction of the E-field does not vary with rotation of the antenna, as it is coupled rotational-invariant through the circular waveguides 32, 34, and the circular rotary joint 33, as well as the circular antenna 31.

In FIG. 8, the orientation of the electromagnetic waves as transmitted by first rectangular cross-sectioned antenna is shown in a top view. This figure relates to the embodiment as described in FIG. 6. As the standard rotary joints 69 and 79 maintain the direction of the electrical field, this is always constant with respect to the rotating base and moves with rotation of the rotating base against the scanned area 80. This can be demonstrated by the E-field as shown by the arrows in the cross-sections 96, 97, 98, 99 of a rectangular cross-sectioned antenna 61, 71, at different positions, which are under an angle of approximately 90 degrees to each other. Here, the E-field is maintaining the direction from the outside of the rotating base to the center of rotation. Generally, the term “rectangular cross sectioned antenna” shall mean any antenna having a rectangular cross-section, like a pyramidal horn or a sectoral horn.

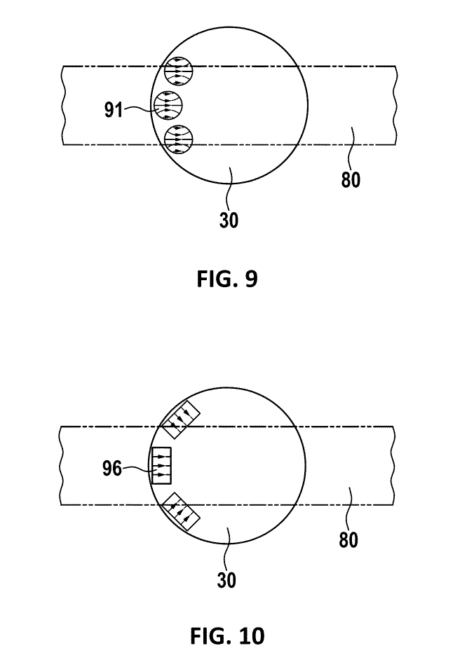

In FIG. 9, the effect of a non-rotating electrical field on scanning is shown. When scanning over the scanned area 80, the direction of the electrical field remains constant with respect to the scanned area, as shown by the arrows of the E-field, although it varies with respect to the rotating base 30. Having a constant orientation of the field and therefore a constant polarization allows to detect polarization modifying (polarizing) properties of the objects. This further helps to improve scanning precision and resolution.

In FIG. 10, the effect of rotating electrical field on scanning is shown. When scanning over the scanned area 80, the direction of the electrical field remains constant with respect to the rotating base 30 and rotates with respect to the scanned area 80, as shown by the arrows of the E-field.

It will be appreciated to those skilled in the art having the benefit of this disclosure that this invention is believed to provide a millimeter wave scanning imaging system. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 conveyor belt
11 direction of movement
12, 13 objects
20 axis of rotation
21 direction of rotation
25 propagation of electromagnetic waves
26 direction of reflected signal
29 image processing unit
30 first rotating base
31 first antenna
32 first circular waveguide
33 first rotary joint
34 first stationary circular waveguide
35 mode converter
36 first stationary rectangular waveguide
37 direction selective coupling device
38 first auxiliary components
39 transmitter
40 second rotating base
41 second antenna
42 second circular waveguide
43 second rotary joint
44 second stationary circular waveguide
45 rectangular waveguide
46 second stationary rectangular waveguide
48 second auxiliary components
49 receiver
50 transmitter system
51 receiver system
61 first rectangular antenna
62 first rotating rectangular waveguide
63 first rotating mode converter
64 first rotating circular waveguide
65 first rotary joint
66 first stationary circular waveguide
67 first stationary mode converter
69 standard rotary joints
71 second rectangular antenna
72 second rotating rectangular waveguide
73 second rotating mode converter
74 second rotating circular waveguide
75 second rotary joint
76 second stationary circular waveguide
77 second stationary mode converter
78 second stationary rectangular waveguide
79 standard rotary joints
80 scan area
81-86 scanned segments
91-94 electrical field of the circular antennas 31, 41
96-99 electrical field of the rectangular antennas 61, 71

1. Millimeter wave scanning imaging system, for scanning objects, the system comprising:
a transport means for transporting the objects in a first direction,
a millimeter wave measurement system comprising a transmitter system coupled to a first antenna, and a receiver system coupled to a second antenna, the first antenna spaced from the second antenna by a distance sufficient to form a gap through which the objects can be transported by the transport means,
a scanning system configured to move the first antenna and the second antenna along an arc-shaped path that crosses the transport means, a portion of the path being at a right angle to the first direction,
wherein the first antenna and the second antenna are rotatable synchronous to each other,
wherein the transmitter system is configured to generate an H₁₁ mode signal and propagate the H₁₁ mode signal to the first antenna via sequentially a first stationary circular waveguide, a first rotary joint, and a first rotating circular waveguide, and
wherein the first antenna comprises a circular antenna, a conical antenna, or a circular conical antenna.

2. Scanning imaging system according to claim 1, wherein the transmitter system comprises a transmitter configured to generate an H₁₀ mode signal and propagate the H₁₀ mode signal through a first stationary rectangular waveguide to a mode converter to convert the H₁₀ mode signal into an H₁₁ mode signal.

3. Scanning imaging system according to claim 1, wherein the transmitter system comprises a transmitter configured to generate an H₁₁ mode signal.

4. Scanning imaging system according to claim 1, wherein the receiver system comprises a receiver configured to receive an H₁₀ mode signal, and the imaging system is configured to propagate a signal to the receiver via sequentially a mode converter to convert an H₁₁ mode signal into an H₁₀ mode signal, and a first stationary rectangular waveguide.

5. Scanning imaging system according to claim 1, wherein the receiver system comprises a receiver configured to receive an H₁₁ mode signal.

6. Scanning imaging system according to claim 1, wherein the second antenna is coupled to the receiver via a second rotary joint.

7. Scanning imaging system according to claim 6, wherein the second antenna comprises a circular antenna configured to receive an H₁₁ mode signal, and the imaging system is configured to propagate the H₁₁ mode signal from the second antenna to the receiver via sequentially a second rotating circular waveguide, the second rotary joint, a second stationary circular waveguide.

8. Scanning imaging system according to claim 6, wherein the second antenna comprises a rectangular antenna, and the imaging system is configured to propagate a signal from the second antenna to the receiver via sequentially a rectangular waveguide, the second rotary joint being configured for use with the rectangular waveguide, and a further rectangular waveguide.

9. Scanning imaging system according to claim 1, wherein the first transport means comprises a belt conveyor.

10. Scanning imaging system according to claim 1, further comprising an image-processing unit coupled to the receiver, the transmitter, or both the receiver and the transmitter.

11. Scanning imaging system according to claim 1, further comprising a mode converter configured to generate a circular polarized H₁₁ mode signal, to receive a circular polarized H₁₁ mode signal, or to generate and receive a circular polarized H₁₁ mode signal.

12. Millimeter wave scanning imaging system, for scanning objects, comprising:
a transport means for transporting the objects in a first direction,
a millimeter wave measurement system comprising a transmitter system coupled to an antenna, and a receiver system coupled to the antenna, the antenna spaced from the transport means by a distance sufficient to form a gap through which the objects can be transported,
a scanning system configured to move the antenna along an arc-shaped path that crosses the transport means, a portion of the path being at a right angle to the first direction,
wherein the transmitter system is configured to generate an H₁₁ mode signal and propagate the H₁₁ mode signal to the antenna via sequentially a first stationary circular waveguide, a rotary joint, and a first rotating circular waveguide,
wherein the antenna comprises a circular antenna,
wherein the antenna is configured to transmit a signal, which may at least partially be reflected by at least one of the objects, and to receive signal reflected by the at least one of the objects, and
the imaging system is configured to propagate the received signal in an H₁₁ mode to the receiver system via sequentially the first rotating circular waveguide, the rotary joint, and the first stationary circular waveguide.

13. Scanning imaging system according to claim 12, wherein the transmitter system comprises a transmitter configured to generate an H₁₀ mode signal and propagate the H₁₀ mode signal via sequentially a first stationary rectangular waveguide and a mode converter to converting the H₁₀ mode signal into an H₁₁ mode signal.

14. Scanning imaging system according to claim 12, wherein the transmitter system comprises a transmitter configured to generate an H₁₁ mode signal.

15. Scanning imaging system according to claim 12, wherein the receiver system comprises a receiver configured to receive an H₁₀ mode signal, and the imaging system is configured to propagate a signal to the receiver via sequentially a mode converter to convert an H₁₁ mode signal into an H₁₀ mode signal, and a first stationary rectangular waveguide.

16. Scanning imaging system according to claim 12, wherein the receiver system comprises a receiver configured to receive a H₁₁ mode signal.

17. Scanning imaging system according to claim 12, wherein the first transport means comprises a belt conveyor.

18. Scanning imaging system according to claim 12, further comprising an image-processing unit coupled to the receiver, the transmitter, or the receiver and the transmitter.

19. Scanning imaging system according to claim 12, further comprising a mode converter configured to generate a circular polarized H₁₁ mode signal, to receive a circular polarized H₁₁ mode signal, or to generate and receive a circular polarized H₁₁ mode signal.

20. Method for operating a scanning imaging system having stationary parts and a rotating part, the stationary parts including a stationary transmitter coupled to a rotating antenna that is circular, conical, or circular conical, wherein the imaging system is configured to propagate signals from the transmitter to the antenna via sequentially a first stationary rectangular waveguide in H₁₀ mode, a mode converter configured to convert an H₁₀ mode signal into an H₁₁ mode signal, a first stationary circular waveguide, a first rotary joint, and a first rotating circular waveguide, the method comprising:
propagating a signal from the transmitter to the antenna while keeping the polarization of the signal constant over rotation with respect to the stationary parts.
